(19) United States
(12) Patent Application Publication
(10) Pub. No.: US 2017/0061011 A1
(43) Pub. Date: Mar. 2, 2017

(54) SERVER AND DATA SEARCH METHOD

(71) Applicant: International Mobile IOT Corp, Taipei (TW)

(72) Inventor: JUNG-TANG HUANG, Taipei (TW)

(73) Assignee: INTERNATIONAL MOBILE IOT CORP, Taipei (TW)

(21) Appl. No.: 14/835,292

(22) Filed: Aug. 25, 2015

(51) Int. Cl. G06F 17/30; H04L 29/06; H04L 29/08

(52) U.S. Cl. CPC G06F 17/30867; H04L 67/02; H04L 67/42

(57) ABSTRACT

A server and a data search method using the server based on the Internet of thing (IoT) technology are provided. The data search method is realized by using a server connected to a first database, a second database, and a sensor via a network, the data search method including: saving sensed data into the first database after the server receives the sensed data from the sensor; detecting an event and analyzing the event to obtain at least one keyword from the event; searching webpage data from the second database; analyzing the webpage data and obtaining at least one factor corresponding to the event from the webpage data; obtaining the sensed data from the first database; verifying the at least one factor corresponding to the event according to the sensed data.

### FIELD

The subject matter herein generally relates to search technology, and particularly to a server and a data search method using the server based on the Internet of things (IoT) technology.

### BACKGROUND

A search engine is used for searching information from a network (for example, the Internet). If a user has a disease, such as hypertension, for example, the user may use the search engine to find out a cause of hypertension. However, the search engine may provide a lot of webpage including many answers, such as lack of exercise, irregular life, or bad eating habits, and the user may not be able to determine which answer is exactly related based on the search results.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an exemplary embodiment of a data search system.

FIG. 2 is a block diagram of an exemplary embodiment of a server in FIG. 1.

FIG. 3 is a flowchart of an exemplary embodiment of a data search method using the server.

FIG. 4 is a flow chart regarding an exemplary embodiment for saving sensed data into a first database.

FIG. 5 is a flowchart of another exemplary embodiment of the data search method using the server.

FIG. 6 shows a diagrammatic view of an exemplary embodiment of a blood glucose level chart of a user including a health range.

FIGS. 7a and 7b show a diagrammatic view of an exemplary embodiment of a blood glucose level chart of the user including the health range and risk ranges.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

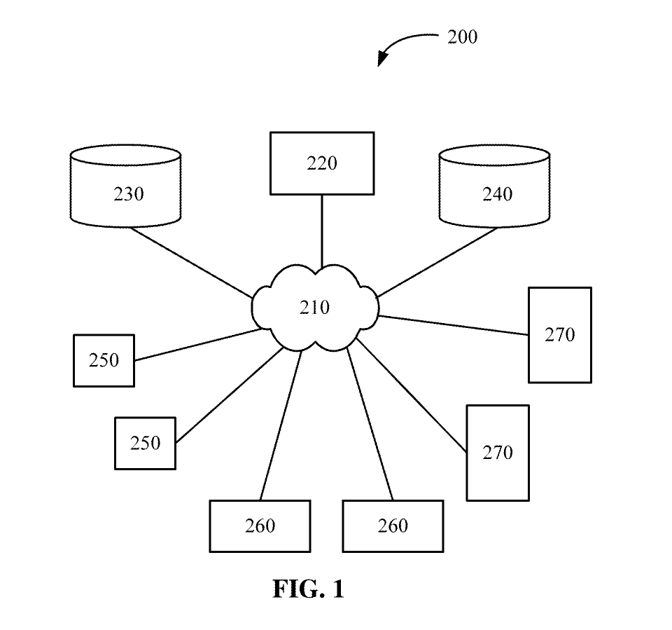

FIG. 1 is a block diagram of an exemplary embodiment of a data search system 200. In one embodiment, the data search system 200 may include a network 210, at least one server 220 (e.g., one server 220 shown in FIG. 1), at least one first database 230 (e.g., one first database 230 shown in FIG. 1), at least one second database 240 (e.g., one second database 240 shown in FIG. 1), a plurality of sensors 250 (e.g., two sensors 250 shown in FIG. 1), a plurality of actuating devices 260 (e.g., two actuating devices 260 shown in FIG. 1), and a plurality of clients 270 (e.g., two clients 270 shown in FIG. 1). The at least one server 220, the at least one first database 230, the at least one second database 240, the plurality of sensors 250, the plurality of actuating devices 260, and the plurality of clients 270 are connected to each other via the network 210. For example, the clients 270 are connected to the server 220 via the network 210, so the clients 270 are able to communicate with the server 220. In addition, the at least one server 220 may be designed for cloud computing capability and capacity. The network 210 may be, but is not limited to, a wide area network (WAN), such as the Internet, a local area network (LAN), a wireless personal area network (PAN), a wireless LAN, a wireless mesh network, a wireless metropolitan area network, a wireless WAN, a cellular network or the like.

Using open database connectivity (ODBC) or java database connectivity (JDBC), for example, the server 220 and the clients 270 are connected to the first databases 230 and the second databases 240. The clients 270 may be, but are not limited to, a mobile phone, a tablet computer, a wearable device, a personal digital assistant (PDA) device, a personal computer or any other electronic devices that provides functions of network connections.

In addition, the data search system 200 can be integrated with one or more other systems which run on Internet of things (IoT), such as a healthcare system, a smart home system, an environment monitoring system, a fire prevention system or the like. The sensors 250 are used to generate sensed data. For example, if the data search system 200 is integrated with the healthcare system, the sensors 250 are used to detect physiological data of a user and generate sensed data, such as a blood pressure of the user, a blood glucose level of the user, a cholesterol level of the user, a triglyceride level of the user or a brain wave of the user. Given the situation, the sensors 250 may be, but are not limited to, a sphygmomanometer, an oxihemometer, an electroencephalograph, a gyroscope, a triaxial accelerometer, a glucose meter or the like. If the data search system 200 is integrated with the environment monitoring system, the sensors 250 are used to detect the environmental data and generate sensed data, such as temperature, humidity, air pressure, air quality, ambient light or the like. Given the situation, the sensors 250 may be, but are not limited to, a thermometer, a hygrometer, a barometer, a luminance meter or the like. If the data search system 200 is integrated with the fire prevention system, the sensors 250 are used to detect specific data from a predetermined space (e.g., a room) and generate sensed data, such as smoke data. In such a situation, the sensors 250 may be, but are not limited to, a smoke detector, a temperature sensor or the like.

The first database 230 may be used to store the sensed data generated by the sensors 250, and the second database 240 may be used to store webpage data from the Internet. The webpage data may be, but is not limited to, a plurality of webpages. For example, the webpage data may be a webpage containing a detailed introduction of hypertension. Moreover, the webpage data may be associated with the sensed data. For example, if the sensed data is physiological data of the user, the sensed data may be associated with the webpage data containing the detailed introduction of hypertension. FIG. 1 illustrates only one example of the data search system 200, and other examples may comprise more or fewer components shown in the embodiment, or have a different configuration of the various components.

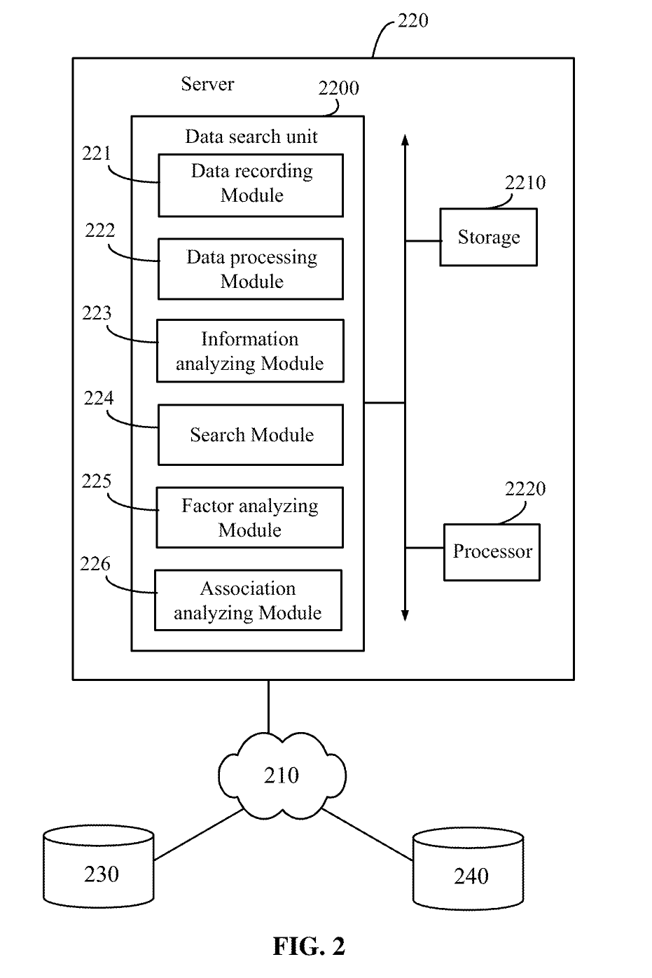

FIG. 2 is a block diagram of an exemplary embodiment of the server 220 in FIG. 1. The server 220 is connected to the first database 230 and the second database 240 via the network 210. The server 220 includes, but is not limited to, a data search unit 2200, a storage 2210, and at least one processor 2220. FIG. 2 illustrates only one example of the server 220, and other examples may comprise more or fewer components shown in the embodiment, or have a different configuration of the various components.

In one embodiment, the storage 2210 may be an internal storage, such as a flash memory, a random access memory (RAM) for temporary storage of information, and/or a read-only memory (ROM) for permanent storage of information. The storage 2210 may also be an external storage, such as an external hard disk, a storage card, or any other data storage medium. The at least one processor 2220 may be a central processing unit (CPU), a microprocessor, or any other data processor chip that performs functions of the server 220.

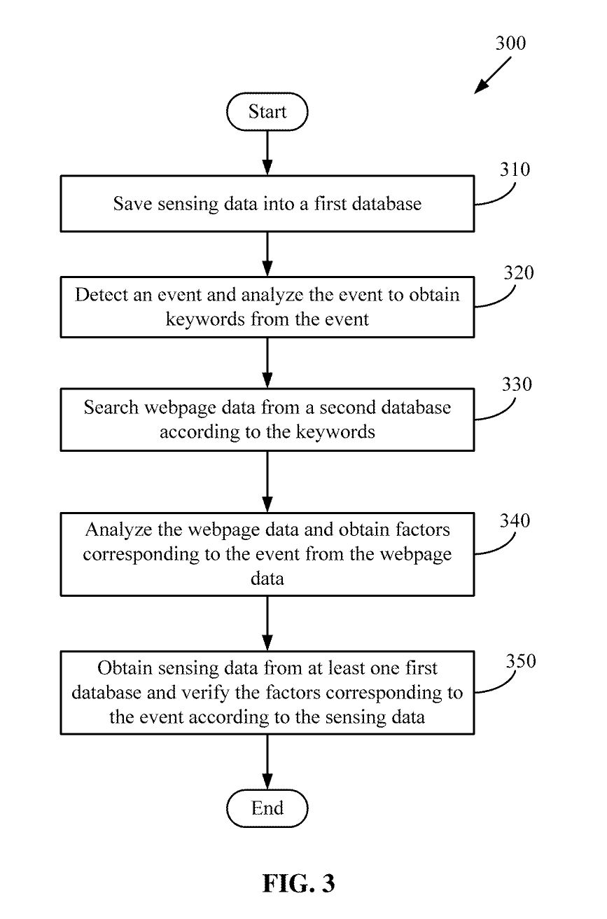

Also, the data search unit 2200 includes, but is not limited to, a data recording module 221, a data processing module 222, an information analyzing module 223, a search module 224, a factor analyzing module 225, and an association analyzing module 226. Modules 221-226 may comprise computerized instructions in the form of one or more computer-readable programs that can be stored in a non-transitory computer-readable medium, such as the storage 2210, and executed by the at least one processor 2220 of the server 220. A detailed description of the functions of the modules 221-226 is given below in reference to FIG. 3.

FIG. 3 illustrates a flowchart of an exemplary embodiment of a data search method 300 using the server. In the exemplary embodiment, the data search method 300 is implemented by computer-readable programs or computerized instructions and is performed by at least one processor of the server.

Referring to FIG. 3, a flowchart is presented in accordance with the exemplary embodiment. The data search method 300 is provided by way of example, as there are a variety of ways to carry out the method. The data search method 300 described below may be carried out using the configurations illustrated in FIGS. 1-3, for example, and various elements of these figures may be referenced in explaining data search method 300. Each block shown in FIG. 3 represents one or more processes, methods, or subroutines, carried out in the data search method 300. Furthermore, the order of blocks is for illustration only and can be changed. Additional blocks may be added or fewer blocks may be utilized without departing from this disclosure. The method 300 may begin at block 310.

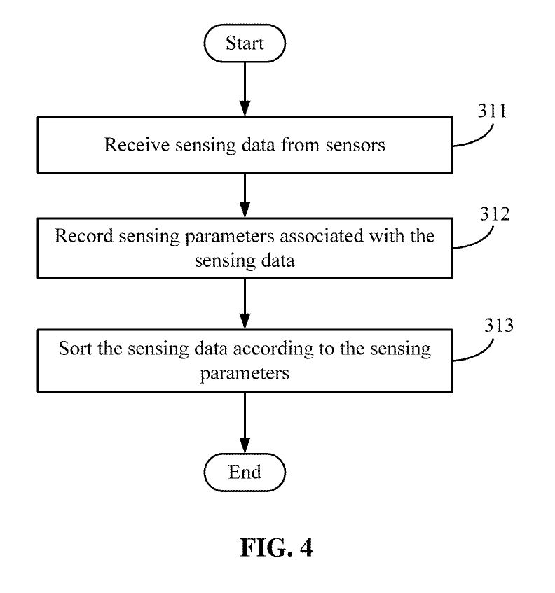

At block 310, the data recording module receives sensed data from the sensors in a time interval (e.g., five seconds) and the data processing module processes the sensed data and saves the processed sensed data into the first database. A detailed description of the block 310 is given below in reference to FIG. 4. In one embodiment, the sensed data is associated with sensing parameters. The sensing parameters include, but not limited to, a recording time of the sensed data, a name of each sensor, an Internet Protocol (IP) address of each sensor, a media access control (MAC) address of each sensor, a location where the sensed data is recorded, a name of the user in charge of each sensor, a name of a department which owes each sensor or the like. The sensed data is saved into the first database according to the sensing parameters. For example, the sensed data is sorted by the recording time of the sensed data, and is saved into the first database according to the recording time of the sensed data. Namely, the sensed data may be searched according to the sensing parameters from the first database.

At block 320, the information analyzing module detects an event and analyzes the event to obtain at least one keyword from the event.

In at least one embodiment, the event is an action or occurrence detected by the information analyzing module and is triggered upon a condition that abnormal sensed data is recorded from the sensors. In at least one embodiment, the sensed data is regarded as the abnormal sensed data when the sensed data does not fall within a predetermined range. The predetermined range is considered as normal or healthy and is suggested by a doctor according to medical experience of the doctor or the medical data (e.g., a medical textbook). For example, assuming that the sensed data is the physiological data of the user (e.g., a blood pressure of the user, a foot steps of the user, or a brain wave of the user), if the physiological data of the user (e.g., the blood pressure of the user) exceeds a predetermined value (e.g., a 140 mmHg for systolic pressure), the sensed data is regarded as abnormal sensed data. In other examples, assuming that the sensed data is the smoke data already detected by the smoke detector, the sensed data is regarded as abnormal sensed data.

The at least one keyword is obtained through associating the abnormal sensed data of the event with the information in the server. The at least one keyword may be, but is not limited to, the name of the user in charge of one sensor, the name of one sensor or the like. The at least one keyword may be predetermined into the server and associated with one sensor and/or the user. So, if the abnormal sensed data is recorded from the sensor, the at least one keyword is obtained. For example, the at least one keyword is predetermined as “hypertension” and “A”, and the keyword “hypertension” is associated with the hamnatodynamometer and the keyword “A” is associated with a name of the user in charge of the hamnatodynamometer. If the abnormal sensed data is recorded from the hamnatodynamometer, “hypertension” and “A” are obtained as the keywords. In addition, information of the event is also provided by the server, including a time of the event, a location of the sensor which generates the abnormal sensed data, a name of the sensor which generates the abnormal sensed data, and/or a name of the user in charge of the sensor which generates the abnormal sensed data. In addition, more sensors may be used for measuring physiological data of a user A. For example, the keyword “high body temperature” or “low body temperature” is associated with the thermometer based on a predetermined temperature interval which is a range considered as normal; in another example, the keyword “high heartbeat rate” or “low heartbeat rate” is associated with the device related to heartbeat detection based on a predetermined heartbeat rate interval which is a range considered as normal. The keyword may also be related to “sleep time” using pressure sensors set on the bed. The normal ranges may also be determined by the user or based on continuous measurement of the user as user-specific parameters since there are individual differences between each user.

In at least another embodiment, the event may also be an action or occurrence detected by the information analyzing module when the server receives keywords input by the user from the client. Namely, if the user inputs keywords (e.g., “hypertension” or “A”) in an interface of the client, the event is triggered when the keyword is received by the server. Given the situation, the information of the event may include the time of the event, a name of the user who inputs the keywords in the client or the like.

At block 330, the search module searches webpage data from the second database according to the at least one keyword. For example, if a keyword “hypertension” is used for search, the webpage data including “hypertension” will be searched. In addition, official websites may be in high priorities during search.

At block 340, the factor analyzing module analyzes the webpage data and obtains at least one factor corresponding to the event from the webpage data. For example, the factor analyzing module analyzes the webpage data including the detailed introduction of hypertension to obtain one or more factors corresponding to the event, such as lack of exercise, irregular lifestyle, bad eating habits or the like. In addition, more than one websites may be analyzed for each event to obtain one or more factors according to an intersection (for exact comparison) or a union (for vague comparison) of various webpage data. Alternatively, the factors corresponding to the event may be predetermined into the second database. Namely, the factors corresponding to the event are directly obtained from the second database, and the factor analyzing module 225 does not need to analyze the webpage data.

At block 350, the association analyzing module obtains sensed data from the first database according to information of the event and the factors corresponding to the event, and verifies the factors corresponding to the event according to the sensed data. For example, if the information of the event includes the user A, the sensed data associated with the user A will be obtained according to the information of the event, such as the blood pressure of the user A, the steps of the user A, the activity of the user A, the brain wave of the user A, and the glucose level of the user A. Then, the association analyzing module verifies the factors corresponding to the event according to the sensed data. For example, if a factor corresponding to the event is lack of exercise, the sensed data including the steps and/or activity of the user A can determine if the user A really lacks exercise or not. If a factor corresponding to the event is bad eating habits, the sensed data including the glucose in the blood of the user A can determine if the user A really has bad eating habits or not. Alternatively, different sets of factors related to the keywords of the detected event can be compared to the sensed data corresponding to each factor, if possible, to obtain a score of correlation, and thus the analysis result of possible diseases to the event can be provided to the user. In detail, if a disease has symptoms related to factors of high blood pressure, low body temperature and high heartbeat rate, the server can check the sensed data from the corresponding sensors to obtain a score of matches to rank possible diseases. In addition, the association analyzing module provides a solution to solve each factor corresponding to the event. For example, if the user A really has bad eating habits, the solution can be provided as a file about how to adjust the eating habits for the user A. The solution may also be activating actuating devices. For example, if the user A lacks sleep based on the sleep time records of the user A, the actuating device may be a light controller to dim the light to help the user A sleep. Furthermore, the solution may be, but is not limited to, an audio file, a video file, a text file or the combination thereof. For example, the solution may be related to the cognitive behavioral therapy for insomnia, a structured program that helps the user A identify and replace thoughts and behaviors that cause or worsen sleep problems with habits that promote sound sleep. In addition, the first database may provide a sleep diary for a time frame, such as one or two weeks, to help decide how to best treat the insomnia of the user A. The physiological data may be continued to be monitored and saved to the first database for a period of time, and the physiological data may be merged to the user specific data stored in the first database as short-term, medium-term and long-term data based on the length of the period of time, such as one day, one month or one year. A solution recommended by the server and selected by the user may also be stored as a reference for effectiveness. Facilitating the server described above can reduce human recognition bias and provide early alerts for the users.

FIG. 4 is a detailed description of one block 310 in FIG. 3 regarding an exemplary embodiment for saving sensed data into the first database.

At block 311, the data recording module receives sensed data from the sensors. For example, the data recording module may receive physiological data of the user from sensors, such as a sphygmomanometer, an oxihemometer, a pedometer meter, an electroencephalograph, a gyroscope, a triaxial accelerometer, a glucose meter or the like. In addition, the data recording module may receive environment data from the sensors, such as a thermometer, a hygrometer, a barometer, a luminance meter or the like. Moreover, the data recording module may receive smoke data from the sensors, such as a smoke detector or the like.

At block 312, the data recording module further records sensing parameters associated with the sensed data. The sensing parameters are simultaneously generated upon a condition that the sensed data is generated. Namely, the sensing parameters are associated with the sensed data. For example, the sensing parameters include, but not limited to, the recording time of the sensed data, the name of each sensor, the Internet Protocol (IP) address of each sensor, the media access control (MAC) address of each sensor, the location where the sensed data is recorded, the name of the user in charge of each sensor, the name of the department which owns each sensor or the like.

At block 313, the data processing module processes the sensed data according to the sensing parameters and saves the processed sensed data into the first database. In at least one embodiment, the sensed data may be sorted according to the sensing parameters using a technology of data fusion. For example, the sensed data may be sorted according to a name of the user in charge of each sensor. Namely, different sensed data obtained at the same location and from the same sensor are processed into an integration of the multiple sensed data. The integration of the multiple sensed data may be used to analyze a change of the sensed data (e.g., the value of the blood pressure of the user). For example, the sensed data including the blood pressure of the user A are obtained from a sphygmomanometer, and the blood pressure of the user A is sorted according to a hour, a day, a month, and a year using the technology of data fusion, and thus an integration of the multiple blood pressure readings of the user A is generated. The change of the blood pressure of the user A within the hour, the day, the month, and the year may be analyzed according to the integration of the multiple blood pressure rewadings of the user A. It should be noted that the concept of data fusion and the integration of the multiple sensed data may even be utilized by using more than one sensor.

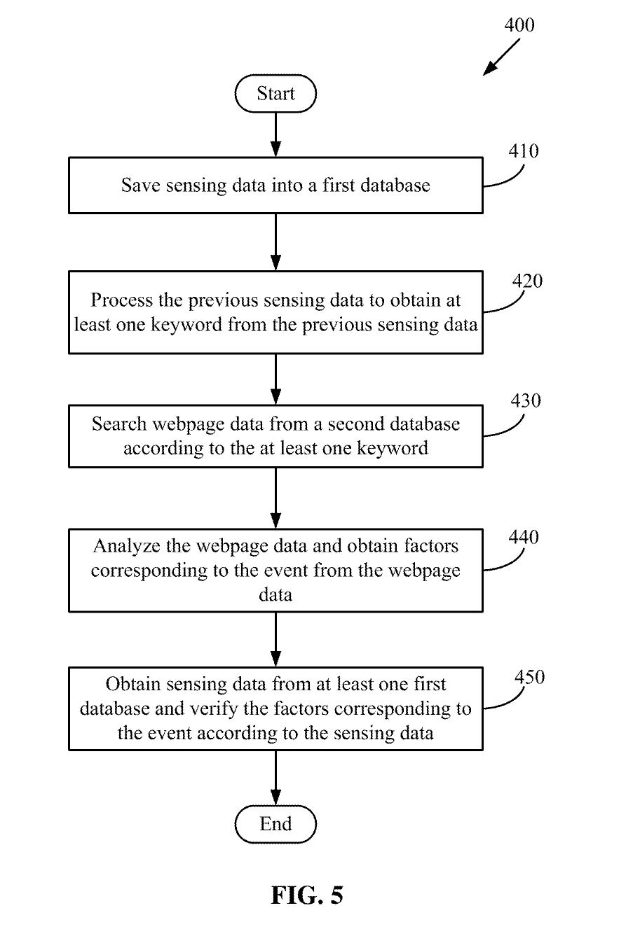

FIG. 5 illustrates a flowchart of another exemplary embodiment of a data search method 400 using the server. In the exemplary embodiment, the data search method 400 is implemented by computer-readable programs or computerized instructions and is performed by at least one processor of the server.

Referring to FIG. 5, a flowchart is presented in accordance with the exemplary embodiment. The data search method 400 is provided by way of example, as there are a variety of ways to carry out the method. The data search method 400 described below may be carried out using the configurations illustrated in FIGS. 1-2 and 5, for example, and various elements of these figures may be referenced in explaining data search method 400. Each block shown in FIG. 5 represents one or more processes, methods, or subroutines, carried out in the data search method 400. Furthermore, the order of blocks is for illustration only and can be changed. Additional blocks may be added or fewer blocks may be utilized without departing from this disclosure. The method 400 may begin at block 410.

At block 410, the data recording module receives sensed data from the sensors in a time interval (e.g., five seconds) and the data processing module processes the sensed data and saves the processed sensed data into the first database. The detailed description of the block 410 is given above in reference to FIG. 4 mentioned above. In one embodiment, the sensed data is associated with sensing parameters. The sensing parameters include, but not limited to, a recording time of the sensed data, a name of each sensor, an IP address of each sensor, a MAC address of each sensor, a location where the sensed data is recorded, a name of the user in charge of each sensor, a name of a department which owns each sensor or the like. The sensed data are saved into the first database according to the sensing parameters. For example, the sensed data is sorted by the recording time of the sensed data, and is saved into the first database according to the recording time of the sensed data. Namely, the sensed data may be searched according to the sensing parameters from the first database.

At block 420, the information analyzing module processes previous sensed data to obtain at least one keyword.

The previous sensed data may be obtained from the first database for different time frames (e.g., one week, one month, one season or one year) or other system (e.g., a healthcare system provided by a hospital). The previous sensed data is used for disease specific health assessment (DSHA). The DSHA includes at least two methods. A first method for DSHA is based on a weight analysis of a factor (e.g., smoking, lack of exercise or the like) related to a disease (e.g., a cancer). Namely, the first method for DSHA uses a weighted risk score to indicate a risk of suffering from a disease (e.g., a cancer). The weighted risk score is calculated based on a relation between a factor (e.g., smoking, lack of exercise or the like) and the disease. A second method for DSHA is based on a mathematical analysis of at least two factors related to the disease. Namely, the second method for DSHA is developed by using the statistics and probability theory to establish a model between the at least two factors and the disease, and the statistics and probability theory may be logistic regression algorithm or Cox regression algorithm, or neural network approaches based on fuzzy mathematics. For example, a Framingham risk score for a coronary heart disease is provided using the second method for DSHA.

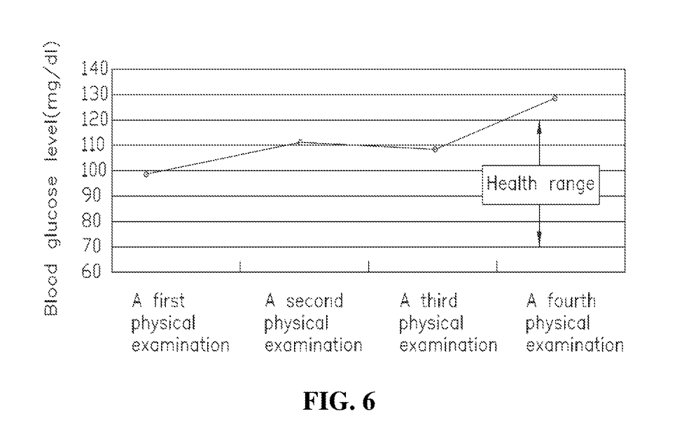

A health range is a range predetermined in the storage which is provided for determining the previous sensed data. The health range may be determined by a doctor according to medical experience of the doctor or the medical data (e.g., a medical textbook). For example, the previous sensed data may include four blood glucose levels of the user named as “A”. The four blood glucose levels of the user named as “A” are shown in a chart of FIG. 6, the blood glucose level chart includes the health range (e.g., 70 mg/dl-120 mg/dl) which is regarded as the predetermined range of the blood glucose levels. If a blood glucose level of the user falls within a health range, the blood glucose level is regarded as the normal previously sensed data. For example, as shown in FIG. 6, a first blood glucose level of the user A in a first physical examination, a second blood glucose level of the user A in a second physical examination, and a third blood glucose level of the user A in a third physical examination are regarded as the normal previous sensed data, and the fourth blood glucose level of the user A in a fourth physical examination is regarded as the abnormal previous sensed data. The health range may also be determined by the user or based on continuous measurement of the user as user-specific parameters since there are individual differences between each user. It should be noted that the abnormal previously sensed data may not be related to a specific disease (e.g., the cancer).

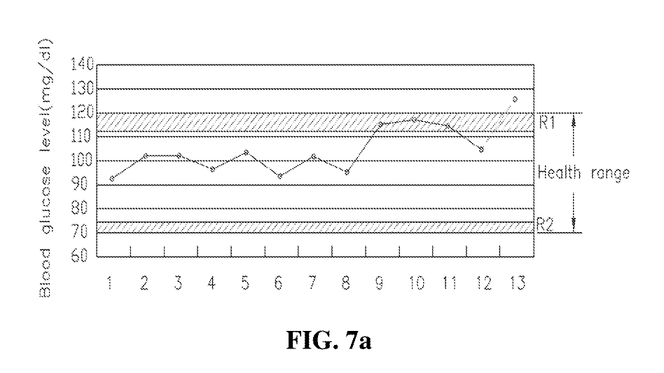

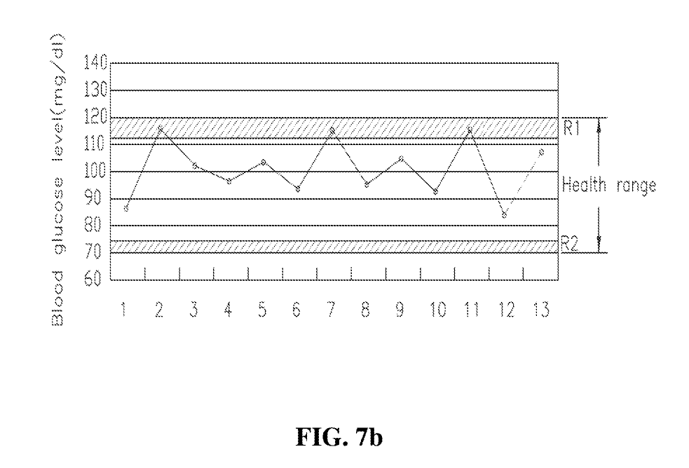

In addition, the health range may include an upper risk range and a lower risk range, and the lower limit of the upper risk range is larger than the upper limit of the lower risk range. For example, as shown in FIG. 7a and 7b, the upper risk range is close to an upper limit (e.g., 120 mg/dl) of the health range, and the lower risk range is close to a lower limit (e.g., 70 mg/dl) of the health range. The risk range and the safe range may be also determined by the doctor according to the medical experience of the doctor or the medical data (e.g., the medical textbook). A predetermined percentage value R is provided to determine the risk range of the health range. Assuming that R is equal to 30%, and the risk range contains 30% of the health range, for example, the upper risk range may contain 15% of the health range, and the lower risk range may contain 15% of the health range, the left 70% of the health range is regarded as a riskless range of the health range. It should be noted that the upper risk range and the lower risk range may not be equal. For example, the upper risk range may contain 10% of the health range, and the lower risk range may contain 20% of the health range. If the previous sensed data falls within the riskless range of the health range, the previous sensed data is determined as safe sensed data. If the previous sensed data falls within the risk range of the health range, the previous sensed data is determined as risk sensed data.

In FIGS. 7a and 7b, an occurrence frequency may be defined as how many times the sensed data is located in the risk range within a time frame (e.g., one week, one month, one season or one year), and a sequential pattern may be defined as a distribution characteristic of the sensed data in the health range within the time frame and is related to a health condition of the user. In addition, a risk level may be calculated based on the occurrence frequency and at least one sequential pattern to predict whether an event may occur in the future. For example, the sequential pattern in FIG. 7a has more dense risk sensed data in a short period of time (e.g., time slots 9 to 11) than the sequential pattern in FIG. 7b, thus causing the risk level in FIG. 7a is higher than the risk level in FIG. 7b. It should be noted that the information analyzing module 223 may delete some of the sensed data in the sequential pattern to better calculate the risk level and predict whether an event may occur.

Thus, if the risk level determines that the event may occur in the future to some extent, the at least one keyword is obtained. The at least one keyword may be, but is not limited to, the name of the user in charge of one sensor, the name of one sensor or the like. More specifically, the at least one keyword may be predetermined into the server and associated with one sensor and/or the user. For example, the at least one keyword is predetermined as “hypertension” and “A”, and the keyword “hypertension” is associated with the hamnatodynamometer and the keyword “A” is associated with a name of the user in charge of the hamnatodynamometer. If the risk sensed data is recorded from the hamnatodynamometer, “hypertension” and “A” are obtained as the keywords. In addition, more sensors may be used for measuring physiological data of a user A. For example, the keyword “high body temperature” or “low body temperature” is associated with the thermometer based on a predetermined temperature interval considered as a health range. For another example, the keyword “high heartbeat rate” or “low heartbeat rate” is associated with the device related to heartbeat detection based on a predetermined heartbeat rate interval considered as a healthy range. The keyword may also be related to “sleep time” using pressure sensors set on the bed.

At block 430, the search module searches webpage data from the second database according to the at least one keyword. For example, if a keyword “hypertension” is used for searching, the webpage data including “hypertension” will be searched. In addition, official websites may be in high priorities during search.

At block 440, the factor analyzing module analyzes the webpage data and obtains at least one factor corresponding to the event from the webpage data. For example, the factor analyzing module analyzes the webpage data including the detailed introduction of hypertension to obtain one or more factors corresponding to the event, such as lack of exercise, irregular lifestyle, bad eating habits or the like. In addition, more than one website may be analyzed for each event to obtain one or more factors according to an intersection (for exact comparison) or a union (for vague comparison) of various webpage data. Alternatively, the factors corresponding to the event may be predetermined into the second database. Namely, the factors corresponding to the event are directly obtained from the second database, and the factor analyzing module does not need to analyze the webpage data.

At block 450, the association analyzing module obtains sensed data from the first database according to information of the event and the factors corresponding to the event, and verifies the factors corresponding to the event according to the sensed data. For example, if the information of the event includes the user A, the sensed data associated with the user A will be obtained according to the information of the event, such as the blood pressure of the user A, the diastolic pressure of the user A, the foot pressure of the user A, the brain wave of the user A, and the glucose in the blood of the user A. Then, the association analyzing module verifies the factors corresponding to the event according to the sensed data. For example, if a factor corresponding to the event is lack of exercise, the sensed data including the steps of the user A can determine if the user A really lacks exercise or not. If a factor corresponding to the event is bad eating habits, the sensed data including the glucose in the blood of the user A can determine if the user A really has bad eating habits or not. Alternatively, different sets of factors related to the keywords of the detected event can be compared to the sensed data corresponding to each factor, if possible, to obtain a score of correlation, and thus the analysis result of possible problems to the event can be provided to the user. More specifically, if a disease has symptoms related to factors of high blood pressure, low body temperature and high heartbeat rate, the server can check the sensed data from the corresponding sensors to obtain a score of matches to rank possible problems. In addition, the association analyzing module provides a solution to solve each factor corresponding to the event. For example, if the user A really has bad eating habits, the solution can be provided as a file about how to adjust the eating habits for the user A. The solution may also be activating actuating devices. For example, if the user A lacks sleep based on the sleep time records of the user A, the actuating device 260 may be a light controller to dim the light to help the user A sleep. Furthermore, the solution may be, but is not limited to, an audio file, a video file, a text file or the combination thereof. For example, the solution may be related to the cognitive behavioral therapy for insomnia, a structured program that helps the user A identify and replace thoughts and behaviors that cause or worsen sleep problems with habits that promote sound sleep. In addition, the first database may provide a sleep diary for a time frame, such as one or two weeks, to help decide how to best treat the insomnia of the user A. It should be noted that the physiological data may be continued to be monitored and saved to the first database for a period of time, and the physiological data may be merged to the user specific data stored in the first database as short-term, medium-term and long-term data based on the length of the period of time, such as one day, one month or one year. A solution recommended by the server and selected by the user may also be stored as a reference for effectiveness. Facilitating the server described above can reduce human recognition bias and provide early alerts for the users.

Furthermore, the data search system 200 may be wirelessly connected to at least one robot, and the robot may take a role of the server 220. For example, the robot may execute the computerized codes of the modules 221-226 to carry out the data search method 300 or the data search method 400. In addition, the robot may take a partial role of the server 220. Namely, the robot may execute one or more blocks of the data search method 300 or the data search method 400. For example, the robot may execute the block 310 and 320 and the blocks 330-350 may be still executed by the server 220, or the robot may execute the block 410 and 420 and the blocks 430-450 may be still executed by the server 220. The robot may further include at least one sensor (e.g., the thermometer, the hygrometer, the barometer, or the luminance meter), so that the robot is capable of detecting the environmental data (the temperature of the environment, the humidity of the environment, the air pressure of the environment, the air quality of the environment, the ambient light of the environment or the like). The robot may provide the same function of the client 270, for example, and at least one keyword is input in the robot. In view of the above, the robot may take at least a partial role of the server 220, the sensors 250, or client 270. The robot may be, but is not limited to, a movable robot which is able to move in a specific area (e.g., a house of the user). The robot may forecast the disease which the user is going to suffer from according to the sensed data.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A server connected to a first database, a second database, and a sensor via a network, comprising:
a non-transitory storage medium; and
at least one processor operative to execute instructions stored in the non-transitory storage medium, the instructions causing the processor to:
save sensed data into the first database after the server receives the sensed data from the sensor;
detect an event in the server;
analyze the event to obtain at least one keyword from the event;
search webpage data from the second database according to the at least one keyword;
analyze the webpage data;
obtain at least one factor corresponding to the event from the webpage data;
obtain the sensed data from the first database according to information of the event and the at least one factor corresponding to the event; and
verify the at least one factor corresponding to the event according to the sensed data.

2. The server of claim 1, wherein the sensed data are associated with sensing parameters which are simultaneously generated upon a condition that the sensed data are generated.

3. The server of claim 2, wherein the sensing parameters comprise a recording time of the sensed data, a name of the sensor, an Internet Protocol (IP) address of the sensor, a media access control (MAC) address of the sensor, a location where the sensed data are recorded, a name of the user in charge of the sensor, and a name of a department which owes the sensor.

4. The server of claim 3, wherein the sensed data are sorted according to the sensing parameters using the technology of data fusion to generate an integration of the multiple sensed data for analyzing a change of the sensed data.

5. The server of claim 1, wherein the event is triggered when abnormal sensed data is detected by the sensor, wherein the abnormal sensed data are defined as the sensed data that do not fall within a predetermined range which stored in the storage.

6. The server of claim 1, wherein the information of the event comprises a time of the event, a location of the sensor which generates the abnormal sensed data, a name of the sensor which generates the abnormal sensed data, and/or a name of the user in charge of the sensor which generates the abnormal sensed data.

7. The server of claim 1, wherein the event is defined as when the server receives the at least one keyword inputted by a user via the network.

8. The server of claim 1, wherein a solution is further provided to solve the at least one factor corresponding to the event.

9. The server of claim 1, wherein the event is triggered by a risk level calculated based on an occurrence frequency and a sequential pattern.

10. A data search method using a server connected to a first database, a second database, and a sensor via a network, the data search method comprising:
saving sensed data into the first database after the server receives the sensed data from the sensor;
detecting an event in the server and analyzing the event to obtain at least one keyword from the event;
searching webpage data from the second database according to the at least one keyword;
analyzing the webpage data and obtaining at least one factor corresponding to the event from the webpage data;
obtaining the sensed data from the first database according to information of the event and the at least one factor corresponding to the event; and
verifying the at least one factor corresponding to the event according to the sensed data.

11. The method of claim 10, wherein the sensed data are associated with sensing parameters which are simultaneously generated upon a condition that the sensed data are generated.

12. The method claim 11, wherein the sensing parameters comprise a recording time of the sensed data, a name of the sensor, an Internet Protocol (IP) address of the sensor, a media access control (MAC) address of the sensor, a location where the sensed data are recorded, a name of the user in charge of the sensor, and a name of a department which owes the sensor.

13. The method of claim 12, wherein the sensed data are sorted according to the sensing parameters using the technology of data fusion to generate an integration of the multiple sensed data for analyzing a change of the sensed data.

14. The method of claim 10, wherein the event is triggered when abnormal sensed data is detected by the sensor, wherein the abnormal sensed data are defined as the sensed data that do not fall within a predetermined range which stored in the storage.

15. The method of claim 10, wherein the information of the event comprises a time of the event, a location of the sensor which generates the abnormal sensed data, a name of the sensor which generates the abnormal sensed data, and/or a name of the user in charge of the sensor which generates the abnormal sensed data.

16. The method of claim 10, where the event is an action or occurrence to receive the at least one keyword inputted in a client connected to the server via the network.

17. The method of claim 10, wherein a solution is further provided to solve the at least one factor corresponding to the event.

18. The method of claim 10, wherein the event is triggered by a risk level calculated based on an occurrence frequency and a sequential pattern.
